(19) United States
(12) Patent Application Publication
(10) Pub. No.: US 2015/0073649 A1
(43) Pub. Date: Mar. 12, 2015

(54) MANAGING DIAGNOSTIC TROUBLE CODES IN A VEHICLE

(71) Applicant: General Motors LLC, Detroit, MI (US)

(72) Inventors: James J. Kelly, III, Ferndale, MI (US); Ryan M. Edwards, Macomb, MI (US); Carl J. Hering, Farmington Hills, MI (US); Jeffrey J. Olsen, Royal Oak, MI (US)

(73) Assignee: General Motors LLC, Detroit, MI (US)

(21) Appl. No.: 14/023,613

(22) Filed: Sep. 11, 2013

(51) Int. Cl. G07C 5/00

(52) U.S. Cl. CPC G07C 5/008
USPC 701/31.4

(57) ABSTRACT

A method of managing diagnostic trouble codes (DTCs) in a vehicle includes generating at a vehicle a plurality of DTCs output from one or more diagnostic subtasks; assigning an ordinal number to each DTC independent of time based on the order in which the DTC occurred at the vehicle; and wirelessly transmitting to a central facility the plurality of DTCs along with the ordinal numbers assigned to each DTC.

### TECHNICAL FIELD

The present invention relates to vehicle diagnostics and more particularly to managing diagnostic trouble codes (DTCs) in a vehicle.

### BACKGROUND

Modern vehicles include on-board systems that can monitor vehicle performance and diagnose problems with vehicle performance when necessary. These on-board systems can be carried out using devices having computer processing capability, such as a vehicle telematics unit, that receive vehicle data from one or more vehicle sensors and monitor vehicle performance. Using the received vehicle data, the on-board systems can determine that the performance of the vehicle is sub-optimal and output a diagnostic trouble code (DTC) that reflects this sub-optimal performance. Some vehicle conditions can cause the on-board system to generate a plurality of DTCs that collectively reflect what is happening at the vehicle.

When the vehicle generates the plurality of DTCs, it can be helpful for diagnosis purposes to know which DTC occurred first, second, third, etc. It is possible to use a clock that is located on the vehicle to determine when the vehicle generates each DTC. However, using a clock is challenging because it requires the presence of a clock, reliance on the accuracy of the clock, and the communication infrastructure needed to access the clock signal.

### SUMMARY

According to an embodiment of the invention, there is provided a method of managing diagnostic trouble codes (DTCs) in a vehicle. The steps include generating at a vehicle a plurality of DTCs output from one or more diagnostic subtasks; assigning an ordinal number to each DTC independent of time based on the order in which the DTC occurred at the vehicle; and wirelessly transmitting to a central facility the plurality of DTCs along with the ordinal numbers assigned to each DTC.

According to another embodiment of the invention, there is provided a method of managing diagnostic trouble codes (DTCs) in a vehicle. The steps include generating at a vehicle a plurality of DTCs output from one or more diagnostic subtasks; storing each DTC of the plurality of DTCs at the vehicle along with a condition that caused each DTC; assigning an ordinal number that is independent of time to each stored DTC and condition; and wirelessly transmitting to a central facility the plurality of DTCs and their corresponding conditions along with the assigned ordinal numbers.

According to yet another embodiment of the invention, there is provided a system of managing diagnostic trouble codes (DTCs) in a vehicle. The system includes a vehicle telematics unit comprising a processor, computer-readable memory, and an antenna, wherein the vehicle telematics unit: receives vehicle operational data from one or more vehicle sensor modules; generates a plurality of DTCs that are output from one or more diagnostic subtasks carried out using the processor; assigns an ordinal number to each DTC independent of time based on the order in which the DTC occurred; and wirelessly transmits to a central facility the plurality of DTCs along with the ordinal number assigned to each DTC via the antenna.

### BRIEF DESCRIPTION OF THE DRAWINGS

One or more embodiments of the invention will hereinafter be described in conjunction with the appended drawings, wherein like designations denote like elements, and wherein:

FIG. 1 is a block diagram depicting an embodiment of a communications system that is capable of utilizing the method disclosed herein; and

FIG. 2 is a flow chart depicting an embodiment of a method of managing diagnostic trouble codes (DTCs) in a vehicle that can be used with the communication system shown in FIG. 1.

### DETAILED DESCRIPTION OF THE ILLUSTRATED EMBODIMENT(S)

The method and system described below manages DTCs or other unit of diagnostic output in a vehicle by assigning an ordinal number to each DTC that is unrelated to time. A different ordinal number can be assigned or linked with each DTC of a plurality of DTCs. By using an ordinal number with each DTC, later analysis can reveal the order in which each DTC occurred and do so without attributing a time value to each DTC that is obtained from a clock. Given that the ordinal number can reveal the numerical order in which each DTC occurred, the use of such numbers can remove the use of a clock to record a time that each DTC occurred.

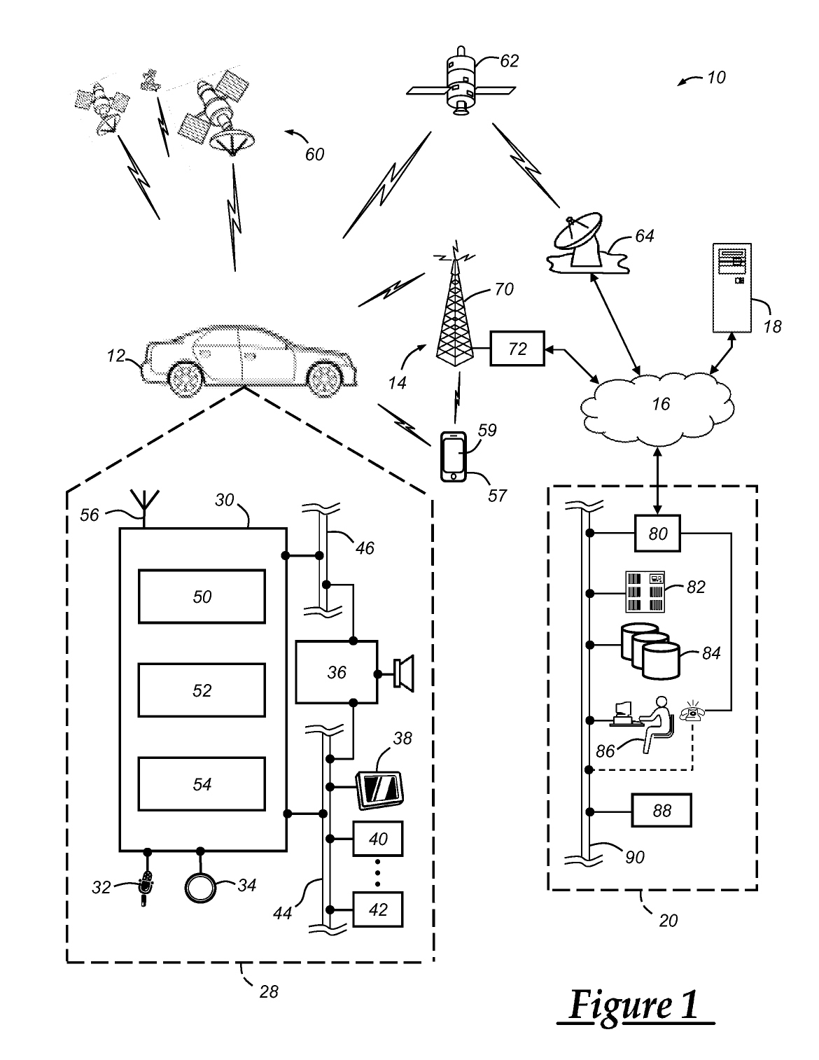

With reference to FIG. 1, there is shown an operating environment that comprises a mobile vehicle communications system 10 and that can be used to implement the method disclosed herein. Communications system 10 generally includes a vehicle 12, one or more wireless carrier systems 14, a land communications network 16, a computer 18, and a call center 20. It should be understood that the disclosed method can be used with any number of different systems and is not specifically limited to the operating environment shown here. Also, the architecture, construction, setup, and operation of the system 10 and its individual components are generally known in the art. Thus, the following paragraphs simply provide a brief overview of one such communications system 10; however, other systems not shown here could employ the disclosed method as well.

Vehicle 12 is depicted in the illustrated embodiment as a passenger car, but it should be appreciated that any other vehicle including motorcycles, trucks, sports utility vehicles (SUVs), recreational vehicles (RVs), marine vessels, aircraft, etc., can also be used. Some of the vehicle electronics 28 is shown generally in FIG. 1 and includes a telematics unit 30, a microphone 32, one or more pushbuttons or other control inputs 34, an audio system 36, a visual display 38, and a GPS module 40 as well as a number of vehicle system modules (VSMs) 42. Some of these devices can be connected directly to the telematics unit such as, for example, the microphone 32 and pushbutton(s) 34, whereas others are indirectly connected using one or more network connections, such as a communications bus 44 or an entertainment bus 46. Examples of suitable network connections include a controller area network (CAN), a media oriented system transfer (MOST), a local interconnection network (LIN), a local area network (LAN), and other appropriate connections such as Ethernet or others that conform with known ISO, SAE and IEEE standards and specifications, to name but a few.

Telematics unit 30 can be an OEM-installed (embedded) or aftermarket device that is installed in the vehicle and that enables wireless voice and/or data communication over wireless carrier system 14 and via wireless networking. This enables the vehicle to communicate with call center 20, other telematics-enabled vehicles, or some other entity or device. The telematics unit preferably uses radio transmissions to establish a communications channel (a voice channel and/or a data channel) with wireless carrier system 14 so that voice and/or data transmissions can be sent and received over the channel. By providing both voice and data communication, telematics unit 30 enables the vehicle to offer a number of different services including those related to navigation, telephony, emergency assistance, diagnostics, infotainment, etc. Data can be sent either via a data connection, such as via packet data transmission over a data channel, or via a voice channel using techniques known in the art. For combined services that involve both voice communication (e.g., with a live advisor or voice response unit at the call center 20) and data communication (e.g., to provide GPS location data or vehicle diagnostic data to the call center 20), the system can utilize a single call over a voice channel and switch as needed between voice and data transmission over the voice channel, and this can be done using techniques known to those skilled in the art.

According to one embodiment, telematics unit 30 utilizes cellular communication according to either GSM or CDMA standards and thus includes a standard cellular chipset 50 for voice communications like hands-free calling, a wireless modem for data transmission, an electronic processing device 52, one or more digital memory devices 54, and a dual antenna 56. It should be appreciated that the modem can either be implemented through software that is stored in the telematics unit and is executed by processor 52, or it can be a separate hardware component located internal or external to telematics unit 30. The modem can operate using any number of different standards or protocols such as EVDO, CDMA, GPRS, and EDGE. Wireless networking between the vehicle and other networked devices can also be carried out using telematics unit 30. For this purpose, telematics unit 30 can be configured to communicate wirelessly according to one or more wireless protocols, such as any of the IEEE 802.11 protocols, WiMAX, or Bluetooth. When used for packet-switched data communication such as TCP/IP, the telematics unit can be configured with a static IP address or can set up to automatically receive an assigned IP address from another device on the network such as a router or from a network address server.

Processor 52 can be any type of device capable of processing electronic instructions including microprocessors, microcontrollers, host processors, controllers, vehicle communication processors, and application specific integrated circuits (ASICs). It can be a dedicated processor used only for telematics unit 30 or can be shared with other vehicle systems. Processor 52 executes various types of digitally-stored instructions, such as software or firmware programs stored in memory 54, which enable the telematics unit to provide a wide variety of services. For instance, processor 52 can execute programs or process data to carry out at least a part of the method discussed herein.

Telematics unit 30 can be used to provide a diverse range of vehicle services that involve wireless communication to and/or from the vehicle. Such services include: turn-by-turn directions and other navigation-related services that are provided in conjunction with the GPS-based vehicle navigation module 40; airbag deployment notification and other emergency or roadside assistance-related services that are provided in connection with one or more collision sensor interface modules such as a body control module (not shown); diagnostic reporting using one or more diagnostic modules; and infotainment-related services where music, webpages, movies, television programs, videogames and/or other information is downloaded by an infotainment module (not shown) and is stored for current or later playback. The above-listed services are by no means an exhaustive list of all of the capabilities of telematics unit 30, but are simply an enumeration of some of the services that the telematics unit is capable of offering. Furthermore, it should be understood that at least some of the aforementioned modules could be implemented in the form of software instructions saved internal or external to telematics unit 30, they could be hardware components located internal or external to telematics unit 30, or they could be integrated and/or shared with each other or with other systems located throughout the vehicle, to cite but a few possibilities. In the event that the modules are implemented as VSMs 42 located external to telematics unit 30, they could utilize vehicle bus 44 to exchange data and commands with the telematics unit.

GPS module 40 receives radio signals from a constellation 60 of GPS satellites. From these signals, the module 40 can determine vehicle position that is used for providing navigation and other position-related services to the vehicle driver. Navigation information can be presented on the display 38 (or other display within the vehicle) or can be presented verbally such as is done when supplying turn-by-turn navigation. The navigation services can be provided using a dedicated in-vehicle navigation module (which can be part of GPS module 40), or some or all navigation services can be done via telematics unit 30, wherein the position information is sent to a remote location for purposes of providing the vehicle with navigation maps, map annotations (points of interest, restaurants, etc.), route calculations, and the like. The position information can be supplied to call center 20 or other remote computer system, such as computer 18, for other purposes, such as fleet management. Also, new or updated map data can be downloaded to the GPS module 40 from the call center 20 via the telematics unit 30.

Apart from the audio system 36 and GPS module 40, the vehicle 12 can include other vehicle system modules (VSMs) 42 in the form of electronic hardware components that are located throughout the vehicle and typically receive input from one or more sensors and use the sensed input to perform diagnostic, monitoring, control, reporting and/or other functions. Each of the VSMs 42 is preferably connected by communications bus 44 to the other VSMs, as well as to the telematics unit 30, and can be programmed to run vehicle system and subsystem diagnostic tests. As examples, one VSM 42 can be an engine control module (ECM) that controls various aspects of engine operation such as fuel ignition and ignition timing, another VSM 42 can be a powertrain control module that regulates operation of one or more components of the vehicle powertrain, and another VSM 42 can be a body control module that governs various electrical components located throughout the vehicle, like the vehicle's power door locks and headlights. According to one embodiment, the engine control module is equipped with on-board diagnostic (OBD) features that provide myriad real-time data, such as that received from various sensors including vehicle emissions sensors, and provide a standardized series of diagnostic trouble codes (DTCs) that allow a technician to rapidly identify and remedy malfunctions within the vehicle. As is appreciated by those skilled in the art, the above-mentioned VSMs are only examples of some of the modules that may be used in vehicle 12, as numerous others are also possible.

Vehicle electronics 28 also includes a number of vehicle user interfaces that provide vehicle occupants with a means of providing and/or receiving information, including microphone 32, pushbuttons(s) 34, audio system 36, and visual display 38. As used herein, the term ‘vehicle user interface’ broadly includes any suitable form of electronic device, including both hardware and software components, which is located on the vehicle and enables a vehicle user to communicate with or through a component of the vehicle. Microphone 32 provides audio input to the telematics unit to enable the driver or other occupant to provide voice commands and carry out hands-free calling via the wireless carrier system 14. For this purpose, it can be connected to an on-board automated voice processing unit utilizing human-machine interface (HMI) technology known in the art. The pushbutton(s) 34 allow manual user input into the telematics unit 30 to initiate wireless telephone calls and provide other data, response, or control input. Separate pushbuttons can be used for initiating emergency calls versus regular service assistance calls to the call center 20. Audio system 36 provides audio output to a vehicle occupant and can be a dedicated, stand-alone system or part of the primary vehicle audio system. According to the particular embodiment shown here, audio system 36 is operatively coupled to both vehicle bus 44 and entertainment bus 46 and can provide AM, FM and satellite radio, CD, DVD and other multimedia functionality. This functionality can be provided in conjunction with or independent of the infotainment module described above. Visual display 38 is preferably a graphics display, such as a touch screen on the instrument panel or a heads-up display reflected off of the windshield, and can be used to provide a multitude of input and output functions. Various other vehicle user interfaces can also be utilized, as the interfaces of FIG. 1 are only an example of one particular implementation.

Wireless carrier system 14 is preferably a cellular telephone system that includes a plurality of cell towers 70 (only one shown), one or more mobile switching centers (MSCs) 72, as well as any other networking components required to connect wireless carrier system 14 with land network 16. Each cell tower 70 includes sending and receiving antennas and a base station, with the base stations from different cell towers being connected to the MSC 72 either directly or via intermediary equipment such as a base station controller. Cellular system 14 can implement any suitable communications technology, including for example, analog technologies such as AMPS, or the newer digital technologies such as CDMA (e.g., CDMA2000) or GSM/GPRS. As will be appreciated by those skilled in the art, various cell tower/base station/MSC arrangements are possible and could be used with wireless system 14. For instance, the base station and cell tower could be co-located at the same site or they could be remotely located from one another, each base station could be responsible for a single cell tower or a single base station could service various cell towers, and various base stations could be coupled to a single MSC, to name but a few of the possible arrangements.

Apart from using wireless carrier system 14, a different wireless carrier system in the form of satellite communication can be used to provide uni-directional or bi-directional communication with the vehicle. This can be done using one or more communication satellites 62 and an uplink transmitting station 64. Uni-directional communication can be, for example, satellite radio services, wherein programming content (news, music, etc.) is received by transmitting station 64, packaged for upload, and then sent to the satellite 62, which broadcasts the programming to subscribers. Bi-directional communication can be, for example, satellite telephony services using satellite 62 to relay telephone communications between the vehicle 12 and station 64. If used, this satellite telephony can be utilized either in addition to or in lieu of wireless carrier system 14.

Land network 16 may be a conventional land-based telecommunications network that is connected to one or more landline telephones and connects wireless carrier system 14 to call center 20. For example, land network 16 may include a public switched telephone network (PSTN) such as that used to provide hardwired telephony, packet-switched data communications, and the Internet infrastructure. One or more segments of land network 16 could be implemented through the use of a standard wired network, a fiber or other optical network, a cable network, power lines, other wireless networks such as wireless local area networks (WLANs), or networks providing broadband wireless access (BWA), or any combination thereof. Furthermore, call center 20 need not be connected via land network 16, but could include wireless telephony equipment so that it can communicate directly with a wireless network, such as wireless carrier system 14.

Computer 18 can be one of a number of computers accessible via a private or public network such as the Internet. Each such computer 18 can be used for one or more purposes, such as a web server accessible by the vehicle via telematics unit 30 and wireless carrier 14. Other such accessible computers 18 can be, for example: a service center computer where diagnostic information and other vehicle data can be uploaded from the vehicle via the telematics unit 30; a client computer used by the vehicle owner or other subscriber for such purposes as accessing or receiving vehicle data or to setting up or configuring subscriber preferences or controlling vehicle functions; or a third party repository to or from which vehicle data or other information is provided, whether by communicating with the vehicle 12 or call center 20, or both. A computer 18 can also be used for providing Internet connectivity such as DNS services or as a network address server that uses DHCP or other suitable protocol to assign an IP address to the vehicle 12.

Call center 20 is designed to provide the vehicle electronics 28 with a number of different system back-end functions and, according to the exemplary embodiment shown here, generally includes one or more switches 80, servers 82, databases 84, live advisors 86, as well as an automated voice response system (VRS) 88, all of which are known in the art. These various call center components are preferably coupled to one another via a wired or wireless local area network 90. Switch 80, which can be a private branch exchange (PBX) switch, routes incoming signals so that voice transmissions are usually sent to either the live adviser 86 by regular phone or to the automated voice response system 88 using VoIP. The live advisor phone can also use VoIP as indicated by the broken line in FIG. 1. VoIP and other data communication through the switch 80 is implemented via a modem (not shown) connected between the switch 80 and network 90. Data transmissions are passed via the modem to server 82 and/or database 84. Database 84 can store account information such as subscriber authentication information, vehicle identifiers, profile records, behavioral patterns, and other pertinent subscriber information. Data transmissions may also be conducted by wireless systems, such as 802.11x, GPRS, and the like. Although the illustrated embodiment has been described as it would be used in conjunction with a manned call center 20 using live advisor 86, it will be appreciated that the call center can instead utilize VRS 88 as an automated advisor or, a combination of VRS 88 and the live advisor 86 can be used.

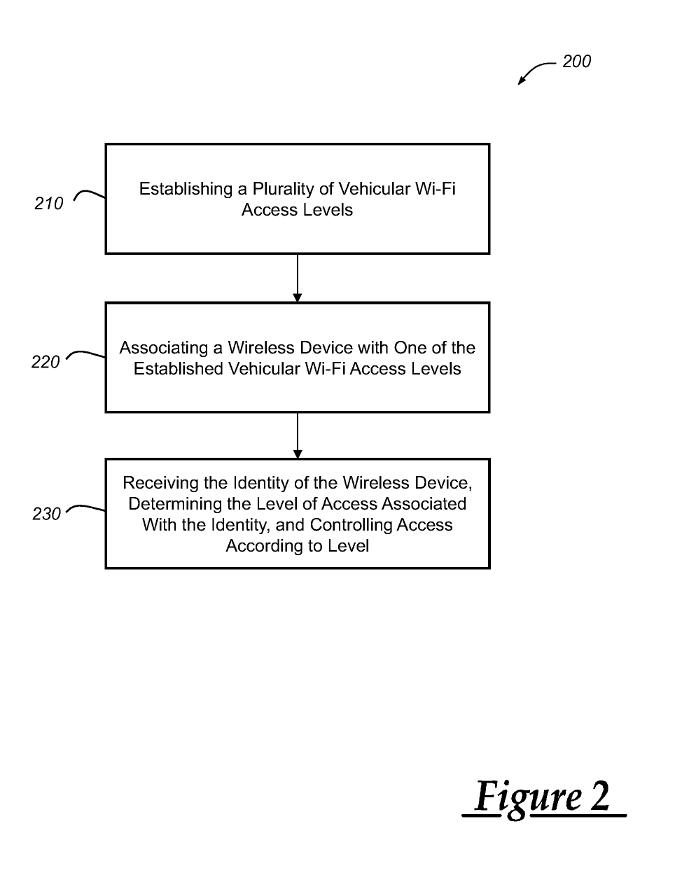

Turning now to FIG. 2, there is shown an embodiment of a method 200 of managing diagnostic trouble codes (DTCs) in the vehicle 12. The method 200 begins at step 210 by generating at the vehicle 12 a plurality of DTCs that are output from one or more diagnostic subtasks. Generally speaking, the vehicle 12 monitors a wide variety of vehicle functions using sensors that gather data relating to those functions. These sensors can monitor the temperature of vehicle components (e.g., the engine and the transmission via their respective fluids), the functionality of vehicle components (e.g., sensors in brake pads indicating significant wear) or of aspects of vehicle operation (e.g., odometer values or oxygen sensor data output). The vehicle telematics unit 30 can receive the data output by the sensors and use that data to generate one or more DTCs based on the data. In one example, data gathered by a sensor can be received at a vehicle system module 42, which can then send the data to the vehicle telematics unit 30 via the communications bus 44. Or in another example, the data can be received by the vehicle telematics unit 30 directly from a sensor.

Regardless of how the vehicle telematics unit 30 receives the data, the unit 30 can include one or more subtasks that analyzes the data and outputs DTCs or some other diagnostic output based on the data. Subtasks can be modular computer programs that are stored in memory 54 and executed by processor 52. The subtasks are modular in the sense that two or more subtasks can work together (or be linked together) such that they collectively analyze the received data. In one example of how this can be accomplished, the data received from a sensor can include an identifier for each subtask that is linked by the Boolean operator AND. When the subtask (or subtasks) receives data, the subtask(s) can implement one or more diagnostic techniques to determine whether the data indicates that a vehicle function is outside of accepted or normal parameters. The subtask can make such a determination by comparing known ranges of acceptable data values with the received data values. When the received data is determined by the subtask to fall outside of the known range of acceptable data, the subtask (or linked subtasks) can generate a DTC.

The DTC that is generated can be followed by other DTCs, resulting in a plurality of DTCs. That is, the problem in vehicle function that is reflected by a first DTC may also be represented by one or more other, subsequent DTCs. Or one or more other, subsequent DTCs may reflect a different problem than the first DTC. But over a period of time, the vehicle telematics unit 30 or vehicle system module 42 can output more than one DTC or diagnostic output that reflects vehicle operation or some abnormal condition of vehicle operation/function. The method 200 proceeds to step 220.

At step 220, each DTC of the plurality of DTCs is stored at the vehicle 12 along with the condition or data that caused each DTC. In one implementation, the DTC can be stored along with a segment of data that caused it. The segment of data can be interpreted to determine the condition that caused each DTC. However, it should be appreciated that in some implementations the DTCs can be stored without the segment of data. For instance, the method 200 can use a sensor buffer for the data that is output from the sensor. The sensor buffer can be included with the processor 52 used by the vehicle telematics unit 30, included with the memory 54, or implemented in another location at the vehicle 12. In that way the data received by the subtask is maintained in the sensor buffer for a period of time, which can be set to an amount that is greater than the time used by a subtask to identify an abnormal condition using that data. When the subtask identifies an abnormal condition of vehicle operation or function, the vehicle telematics unit 30 or the vehicle system module 42 can capture the data used to identify that condition stored in the sensor buffer. The captured data can be associated with the DTC by the vehicle telematics unit 30 using its processing capability (processor 52) and stored at the vehicle 12 (memory 54). This association can be carried out with DTCs that occur or are generated subsequent to earlier ones. And each DTC along with the data captured from the sensor buffer can be stored at the vehicle 12 until the vehicle 12 determines when to wirelessly transmit the plurality of DTCs and buffer data to a central facility, such as a back office facility represented by the computer 18 or the call center 20. The method 200 proceeds to step 230.

At step 230, an ordinal number that is independent of time is assigned to each DTC and condition or sensor data. When the DTC is output or generated, it can be associated with or assigned an ordinal number. And these ordinal numbers can be assigned without reference to the time at which the DTC is output. That is, the DTC may be issued without accessing clock data. For instance, the method 200 can begin assigning ordinal numbers to DTCs after a period of normal vehicle operation has been interrupted by a DTC. At that point, an ordinal buffer can be accessed by the vehicle telematics unit 30 to obtain an ordinal number that is assigned to the first DTC. Both the DTC and the assigned ordinal number (and optionally data from the sensor buffer if it is used) can be stored at the vehicle 12 in memory 54 until it is accompanied by other DTCs/ordinal numbers and sent to the central facility.

In one example, the vehicle 12 may be operating normally until data received by a sensor is sent to a subtask that determines the data falls outside of acceptable ranges. The subtask can then generate a first DTC, which can cause the vehicle telematics unit 30 to access the ordinal buffer and obtain a first ordinal number to assign to the first DTC. The first ordinal number and the first DTC can then be temporarily stored in memory 54. Thereafter, a second DTC may be generated due to a related or unrelated vehicle condition. The vehicle telematics unit 30 can access the ordinal buffer to obtain another (second) ordinal number to assign to the second DTC. Like the first DTC and first ordinal number, the second DTC and second ordinal number can be temporarily stored in memory 54 until it is sent to the central facility. In this example, the first ordinal number can be “01” while the second ordinal number can be “02.” However, it should be appreciated that the value of the ordinal numbers is arbitrary as is the numbering system (i.e., binary, hexidecimal, etc.) and other values/numbering systems can be used so long as they assign values to the DTCs in an ordinal manner. It will be appreciated that steps 210-230 may occur iteratively for each DTC generated such that after step 230 is carried out for a particular DTC, the process of steps 210-230 repeats for the next DTC that occurs. The method 200 proceeds to step 240.

At step 240, the plurality of DTCs and their corresponding conditions are wirelessly transmitted to a central facility along with the assigned ordinal numbers. After assigning the first ordinal number to the first DTC, the method 200 can continue monitoring for additional DTCs (and assigning additional ordinal numbers) for a defined amount of time. This amount of time can be determined in a variety of different ways. For example, the determination of when to stop monitoring for additional DTCs and when to send the plurality of DTCs and ordinal numbers can be based on a predetermined number of ignition cycles (e.g., how many times a driver starts/stops the vehicle 12). It is possible to send with the DTCs and ordinal numbers the data that caused the DTCs but as noted above in some implementations this data is omitted. After the vehicle telematics unit 30 has detected the first DTC, the unit 30 can continue monitoring for additional DTCs until a predetermined number of ignition cycles occur (e.g., five). Once that number of ignition cycles has been detected, the vehicle telematics unit 30 can access the plurality of DTCs and the ordinal numbers assigned to those DTCs and wirelessly transmit them to a central facility. In another example, the vehicle telematics unit 30 can be programmed to monitor for additional DTCs after the first DTC is generated/detected for a fixed amount of time (e.g., 24 hours) that has been established by a vehicle manufacturer and stored at the vehicle 12. When this amount of time has passed, the vehicle telematics unit 30 can access the plurality of DTCs and the ordinal numbers assigned to those DTCs and wirelessly transmit them to a central facility. These are only two of many possible ways that a determination regarding when to send the plurality of DTCs and ordinal numbers can be carried out. Once received by the central facility, the plurality of DTCs can be analyzed according to the order in which they occurred, which is known as a result of their ordinal numbers. The method 200 then ends.

It is to be understood that the foregoing is a description of one or more embodiments of the invention. The invention is not limited to the particular embodiment(s) disclosed herein, but rather is defined solely by the claims below. Furthermore, the statements contained in the foregoing description relate to particular embodiments and are not to be construed as limitations on the scope of the invention or on the definition of terms used in the claims, except where a term or phrase is expressly defined above. Various other embodiments and various changes and modifications to the disclosed embodiment(s) will become apparent to those skilled in the art. All such other embodiments, changes, and modifications are intended to come within the scope of the appended claims.

As used in this specification and claims, the terms “e.g.,” “for example,” “for instance,” “such as,” and “like,” and the verbs “comprising,” “having,” “including,” and their other verb forms, when used in conjunction with a listing of one or more components or other items, are each to be construed as open-ended, meaning that the listing is not to be considered as excluding other, additional components or items. Other terms are to be construed using their broadest reasonable meaning unless they are used in a context that requires a different interpretation.

1. A method of managing diagnostic trouble codes (DTCs) in a vehicle, comprising the steps of:
(a) generating at a vehicle a plurality of DTCs output from one or more diagnostic subtasks;
(b) assigning an ordinal number to each DTC independent of time based on the order in which the DTC occurred at the vehicle; and
(c) wirelessly transmitting to a central facility the plurality of DTCs along with the ordinal numbers assigned to each DTC.

2. The method of claim 1, further comprising the step of capturing a segment of data from a vehicle sensor in a sensor buffer and storing the segment of data when a DTC is generated.

3. The method of claim 1, further comprising the step of obtaining the ordinal number from an ordinal buffer.

4. The method of claim 1, further comprising the step of maintaining data received from a vehicle sensor in a sensor buffer.

5. The method of claim 1, wherein step (a) further comprises comparing data received from a vehicle sensor with a known range of vehicle data.

6. The method of claim 1, further comprising the step of linking two or more diagnostic subtasks together, wherein the diagnostic subtasks are modular.

7. A method of managing diagnostic trouble codes (DTCs) in a vehicle, comprising the steps of:
(a) generating at a vehicle a plurality of DTCs output from one or more diagnostic subtasks;
(b) storing each DTC of the plurality of DTCs at the vehicle along with a condition that caused each DTC;
(c) assigning an ordinal number that is independent of time to each stored DTC and condition; and
(d) wirelessly transmitting to a central facility the plurality of DTCs and their corresponding conditions along with the assigned ordinal numbers.

8. The method of claim 7, further comprising the step of capturing a segment of data that represents the condition from a vehicle sensor in a sensor buffer and storing the segment of data when a DTC is generated.

9. The method of claim 7, further comprising the step of obtaining the ordinal number from an ordinal buffer.

10. The method of claim 7, further comprising the step of maintaining data received from a vehicle sensor in a sensor buffer.

11. The method of claim 7, further comprising the step of comparing data received from a vehicle sensor with a known range of vehicle data.

12. The method of claim 7, further comprising the step of linking two or more diagnostic subtasks together, wherein the diagnostic subtasks are modular.

13. A system of managing diagnostic trouble codes (DTCs) in a vehicle, comprising:
a vehicle telematics unit comprising a processor, computer-readable memory, and an antenna, wherein the vehicle telematics unit:
receives vehicle operational data from one or more vehicle sensor modules;
generates a plurality of DTCs that are output from one or more diagnostic subtasks carried out using the processor;
assigns an ordinal number to each DTC independent of time based on the order in which the DTC occurred; and
wirelessly transmits to a central facility the plurality of DTCs along with the ordinal number assigned to each DTC via the antenna.

14. The system of claim 13, further comprising an ordinal buffer for providing the ordinal number.

15. The system of claim 13, further comprising a sensor buffer for capturing a segment of the vehicle operational data.
